(19) United States
(12) Patent Application Publication
(10) Pub. No.: US 2007/0188520 A1
(43) Pub. Date: Aug. 16, 2007

(54) 3D presentation process and method

(76) Inventors: William Derek Finley, Ottawa (CA); Christopher William Doylend, Ottawa (CA); Gordon Freedman, Nepean (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 11/698,129

(22) Filed: Jan. 26, 2007

Related U.S. Application Data
(60) Provisional application No. 60/762,128, filed on Jan. 26, 2006.
(60) Provisional application No. 60/762,514, filed on Jan. 27, 2006.

(51) Int. Cl. G09G 5/00

(52) U.S. Cl. 345/619

(57) ABSTRACT

The invention relates to a user interface, and method of providing three dimensional presentations of material for improved user understanding. Further the invention allows users to manipulate the direction of the presentation dynamically from within the three dimensional presentation and to transition from one section of a presentation to another by object selection within the three dimensional presentation. The invention achieves this by providing a three dimensional virtual environment comprising firstly the presentation itself, and second objects relating locations within the three dimensional virtual environment to transitions from one region of the presentation to another region of the presentation.

### FIELD OF THE INVENTION

This application claims the benefit of U.S. Provisional Application Nos. 60/762,128, filed on Jan. 26, 2006, and 60/762,514, filed on Jan. 27, 2006, the entire contents of which are incorporated herein by reference.

### FIELD OF THE INVENTION

The present invention relates to user interfaces and more particularly to a method of providing a user interface providing dynamic document navigation within applications.

### BACKGROUND OF THE INVENTION

Data access, retrieval and presentation have always been an important aspect of business, research, marketing, and sales, amongst other activities. Over the years many different data retrieval and data display models have been proposed, starting with original hardcopy printed documents through to today's softcopy documents for being distributed and viewed using computers. However, despite the dramatically increased processing capabilities of such computers most software and application designers have returned to one or other traditional means of presenting information, due to the perceived benefits of their simplicity, ease of use, and user comprehensibility.

In this traditional group of formats the most common model is a sequential based model, wherein the individual or group of individuals preparing information for presentation and dissemination generate an outline, and provide a sequential series of pages, be they hardcopy or softcopy, to present the information. As such this sequential model mirrors the common book format. Recently, applications providing such presentation material to the user have incorporated other elements of the book format and provide an index and section headings allowing the user to navigate according to the traditional method.

However, a presentation of data, including items such as analysis results, project plans, and business decisions, etc by an individual, or by a group of presenters, to a reviewing or a knowledge seeking group of additional individuals is a very dynamic event. Typically, many factors influence the actual flow of the presentation and discussions that ensues between the presenters and reviewers to be different to that envisioned by the presenters and for which their presentation has been prepared. Such factors can be simply that the reviewers already know a section of the presentation, that they wish to discuss an aspect in detail before moving forward generally, or that an assumption employed by the presenters is challenged and modified during the presentation. Typically such factors result in a chaotic “flipping” of pages of the softcopy document to move to and from appropriate sheets of the document being presented, or obsoleting the remainder of the presentation when an assumption is flawed or incorrect.

It would be beneficial for a presenter to have the ability to create and use a softcopy document, in a manner that allows the presenter to adjust dynamically to the situation that is unfolding during the presentation, and to modify either the flow of the presentation or the content of the presentation during the course of the presentation without having to exit the application that is running the document presentation. It would be further beneficial if the user interface of the document presentation application provided for the dynamic inclusion of additional presentation materials, such additional materials addressing possible paths of the discussion but avoiding the requirement for the presenter to merge every possible variant thread of the presentation into the initial presentation materials.

Beneficially, the dynamic linking within the navigation of the document also provides a means for ensuring that the information contained within a presentation is accurate, verified, corporately approved and up to date. These latter aspects typically hinder businesses when, for example, a business with 100 sales personnel has them all using corporate organization charts, which naturally vary, but today every sales person's organization chart is based upon the timing of and the location of the source material they loaded within their presentation.

It would be advantageous to provide a method and a user interface that overcome at least some of the above-mentioned limitations.

### SUMMARY OF THE INVENTION

According to at least one embodiment of the instant invention there is provided a method and a user interface for supporting dynamic navigation of documents being presented.

According to at least one embodiment of the instant invention there is provided a method and a user interface for supporting on-the-fly incorporation of other materials into an existing presentation, on an as-needed basis.

In accordance with the invention there is provided a method comprising: providing presentation data relating to a presentation, the presentation including a plurality of slides, the slides for being traversed in an order, the order relating to links between slides; displaying a slide from the plurality of slides, the slide comprising at least a three dimensional representation of a portion thereof within a three dimensional space; navigating within the three dimensional space of the three dimensional portion; selecting within the three dimensional space a representation therein; and, displaying another slide from the plurality of slides, the other slide selected in dependence upon the selected representation, different other slides displayed for different selected representations.

In accordance with the invention there is provided a computer-readable storage medium having stored thereon computer-executable instructions for a method of providing a user interface, the user interface comprising:

providing presentation data relating to a presentation, the presentation including a plurality of slides, the slides for being traversed in an order, the order relating to links between slides;

displaying a slide from the plurality of slides, the slide comprising at least a three dimensional representation of a portion thereof within a three dimensional space;

navigating within the three dimensional space of the three dimensional portion;

selecting within the three dimensional space a representation therein; and, displaying another slide from the plurality of slides, the other slide selected in dependence upon the selected representation, different other slides displayed for different selected representations.

In accordance with the invention there is provided a computer-readable storage medium having stored thereon computer-executable instructions for a method of providing a user interface, the user interface comprising:
providing a computer-readable storage medium, the computer-readable storage medium having data stored thereon, the data comprising;
   first data at least indicative of the contents and layout of a three dimensional presentation;
   second data relating to a source of a plurality of sources, each source comprising a first predetermined region of the three dimensional presentation and associated with a predetermined transition from the source to a termination associated with the source; and
   application data relating to software application for execution by a processor;
providing a first device, the first input device for receiving user input signals and for providing a first control signals to the processor, the first input device for providing data indicative of at least the location of the user within the three dimensional presentation;
providing a first display, the first display for providing to the user an image generated by the software application, the image comprising;
   a three dimensional visualization associated with the first data, the first data being determined in dependence upon the first control signal; and
   an object added to the three dimensional visualization, the object associated with the second data and being determined in dependence upon the first control signal; and
receiving a user input signal indicating a location matching one of the plurality of sources the first display providing to the user a second image generated by the software application, the second image associated with the termination of the source.

In accordance with the invention there is provided a computer-readable storage medium having stored thereon computer-executable instructions for providing a user interface, the user interface comprising:
a computer-readable storage medium having data stored thereon, the data comprising;
   first data at least indicative of the contents and layout of a three dimensional presentation;
   second data relating to a source of a plurality of sources, each source comprising a first predetermined region of the three dimensional presentation and associated with a predetermined transition from the source to a termination associated with the source; and
   application data relating to software application for execution by a processor;
a first input device for receiving user input signals and for providing a first control signals to the processor, the first input device for providing data indicative of at least the location of the user within the three dimensional presentation;
a first display for providing to the user an image generated by the software application, the image comprising;
   a three dimensional visualization associated with the first data, the first data being determined in dependence upon the first control signal; and
   an object added to the three dimensional visualization, the object associated with the second data and being determined in dependence upon the first control signal; and
upon receiving a user input signal indicating a location matching one of the plurality of sources the first display providing to the user a second image generated by the software application, the second image associated with the termination of the source.

### BRIEF DESCRIPTION OF THE DRAWINGS

Exemplary embodiments of the invention will now be described in conjunction with the following drawings, in which similar reference numerals designate similar items:

FIG. 1 illustrates a prior art document presentation approach employing a book based model;

FIG. 2 illustrates a prior art mechanism for providing a presenter with a means to adjust a presentation;

FIG. 3A (CWD—see the note re numbering at the bottom of the document) illustrates a first presentation based upon a source presentation according to a prior art approach;

FIG. 3B illustrates a first presentation based upon a source presentation according to a prior art approach;

FIG. 4 illustrates a first embodiment of providing a dynamic navigation of a document being presented according to an aspect of the invention;

FIG. 5 illustrates a second embodiment of providing a dynamic navigation of a document being presented according to an aspect of the invention;

FIG. 6 illustrates a third embodiment of providing a dynamic navigation of a document being presented according to an aspect of the invention;

FIG. 7 illustrates a fourth embodiment of providing a dynamic presentation of information according to an aspect of the invention;

FIG. 8 illustrates the resulting variants of the information presentation according to a selection made in the dynamic presentation according to FIG. 7; and,

FIG. 9 illustrates the resulting variants of the information presentation according to a selection made in the dynamic presentation according to FIGS. 7 and 8;

FIG. 10 illustrates a fifth embodiment of the invention of providing dynamic navigation of document being presented according to an aspect of the invention.

FIG. 11 illustrates a sixth embodiment of the invention of providing a dynamic navigation of a document being presented according to an aspect of the invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and the scope of the invention. Thus, the present invention is not intended to be limited to the embodiments disclosed, but is to be accorded the widest scope consistent with the principles and features disclosed herein. It would be evident to one with knowledge in the art that whilst the embodiments are described hereinbelow with particular reference to a visual presentation tool such as Microsoft™ PowerPoint®, the invention is applicable to other applications, including but not limited to spreadsheets, graphical presentations, word processors, computer aided engineering, computer aided design, media players, contact management and personal databases.

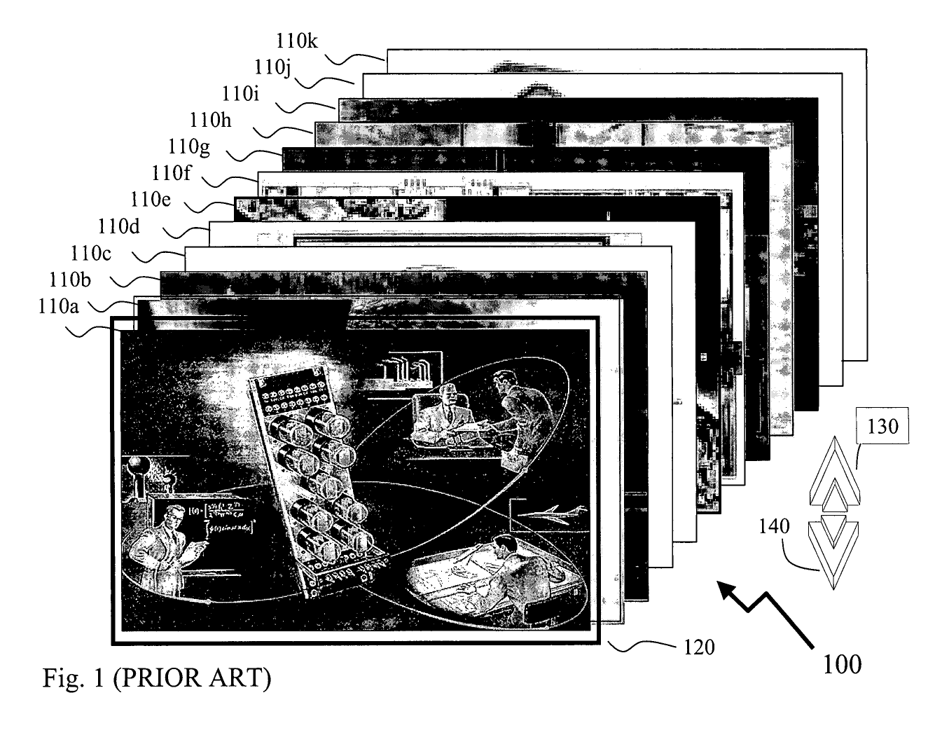

Referring to FIG. 1 shown is a presentation slide-deck 100 of a typical graphical presentation tool such as Microsoft™ PowerPoint®, Harvard Graphics™ Advanced Presentations®, Lotus™ Freelance®, etc. Such a presentation slide-deck 100 comprises a plurality of display sheets 110a, 110b, to 110k, of which one display sheet is the active display sheet 110a currently being displayed on a presentation display (not shown for clarity) by the presenter (not shown for clarity) to an audience (not shown for clarity). The active sheet 110a typically is displayed to the audience as filling the active portion of a display, such as a computer display, laptop computer display, and overhead projector. The presenter having presented the material within the active display sheet 110a then enters a command, typically a page down 140, or equivalently a button on a mouse, thereby triggering the application to move from the current active sheet 110a to the next display sheet in sequence. Repeated selection of a page down 140 and optionally the page up 130, thereby moves the application through a predetermined progression of slide-deck 100.

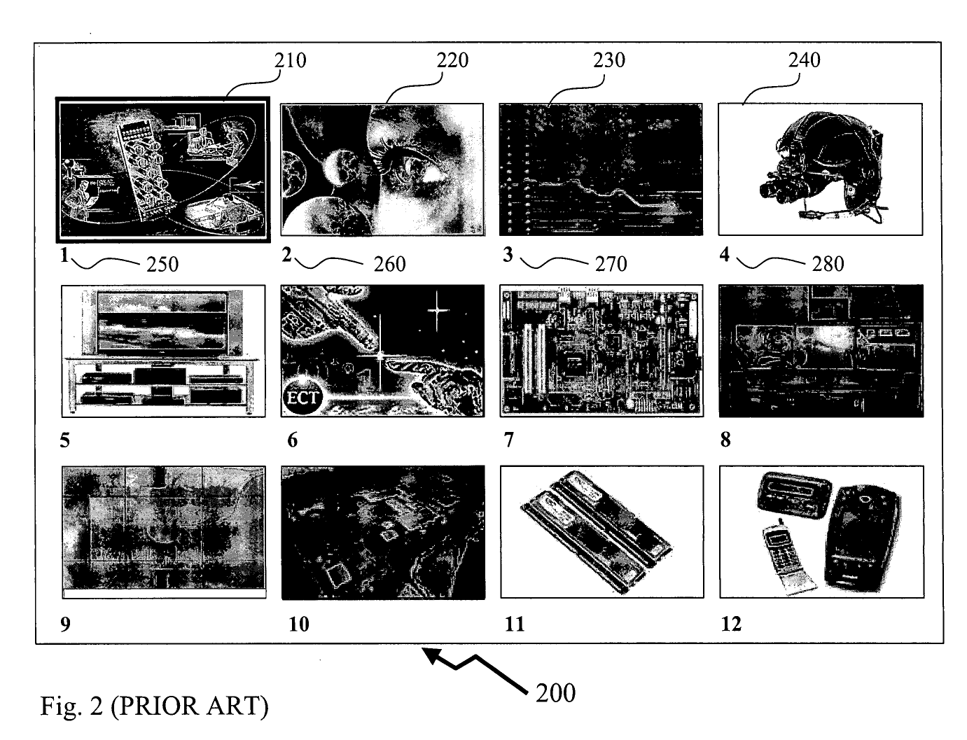

If during the presentation there is a need to move quickly from one part of the presentation slide-deck 100 to another, then the presenter either repeatedly selects the appropriate one of page down 140 or page up 130 repeatedly, thereby creating a chaotic series of fractional or complete images that is displayed to the audience, or the presenter exits the display mode and enters a slide-sorter mode 200 as shown within FIG. 2. As shown within FIG. 2 the 12 sheets of the representative slide-deck 100 are each displayed as small icon images 210 through 240. Hence, the first slide is shown in the upper left as icon image 210 with identifying numeral “1”, the second slide is shown in the upper row as icon image 220 with identifying numeral “2”, the third slide is shown as icon image 230 with identifying numeral “3”, and the fourth slide is shown as icon image 240 with identifying numeral “4”.

It will be appreciated that, unless the icon images 210-240 are very small, which unfortunately makes it more difficult to select a desired display sheet 110 from the slide sorter view, a presentation with a large number of display sheets 110 still requires the presenter to move through multiple views of the slide sorter to find a desired display sheet 110. Accordingly, typically the prior art solutions are designed for non-interactive presentations that are pre-designed. In fact, many of these presentations could be pre-recorded. Options available to a presenter during a presentation are limited and unless a predetermined flow is followed, these options are unsatisfactory, being awkward to use and disruptive to the flow of the presentation.

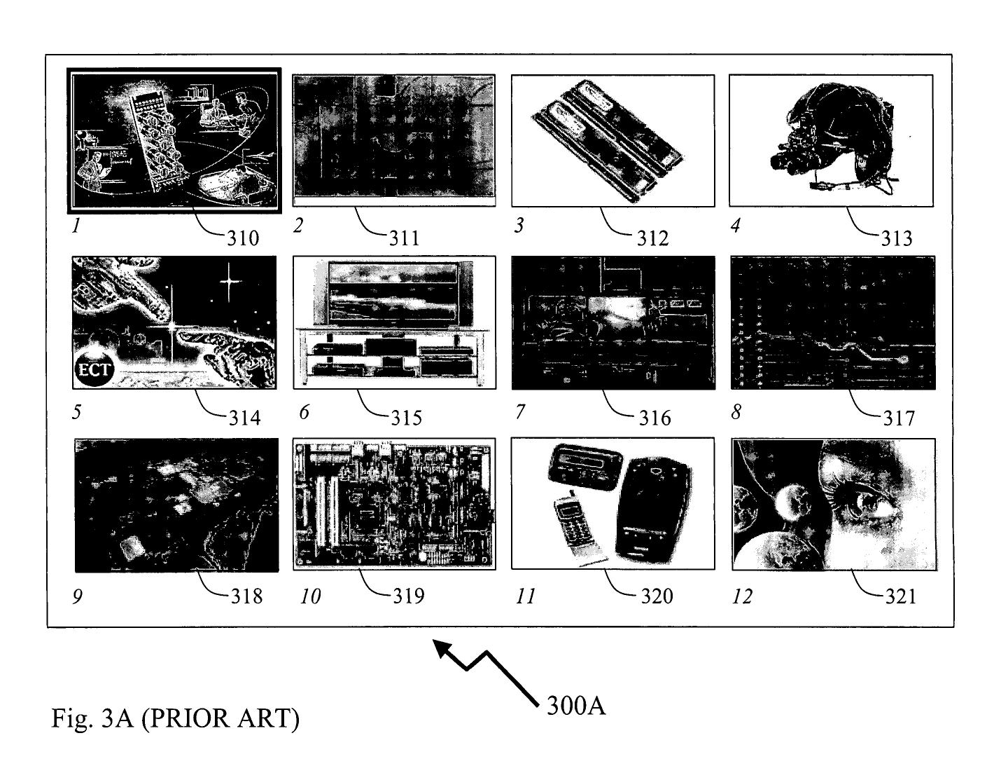

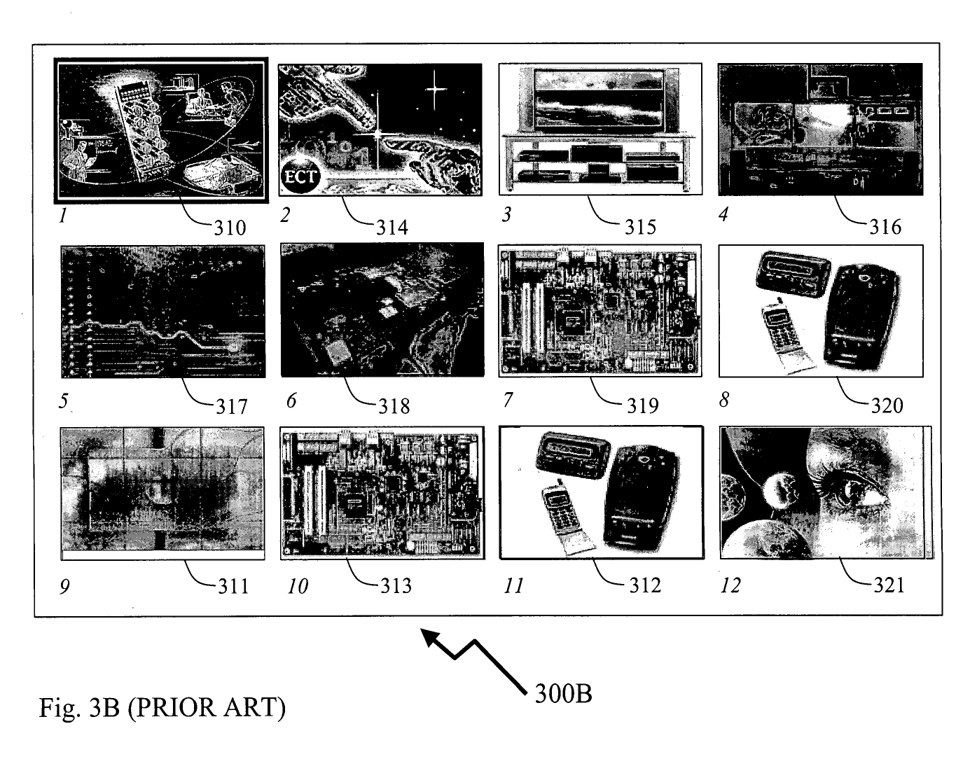

In the event that a presenter guesses a flow of the discussion for each audience, for example a sales person making presentations to different clients or potential clients, then an approach according to FIGS. 3A and 3B may be employed based on the prior art software applications. As shown within the first presentation flow 300A of FIG. 3A there are twelve slides 310 through 321 respectively, representing the display sheets 110, according to the expected flow for a first client. Shown in FIG. 3B is a second presentation flow 300B wherein the sequence of display sheets 110 is varied by the presenter. As shown, the display sheets 110 are now in sequence of first slide 310, second slide 314, third slide 315, fourth through eighth 316 to 320 respectively, ninth 311, tenth 313, eleventh 312, and twelfth 321.

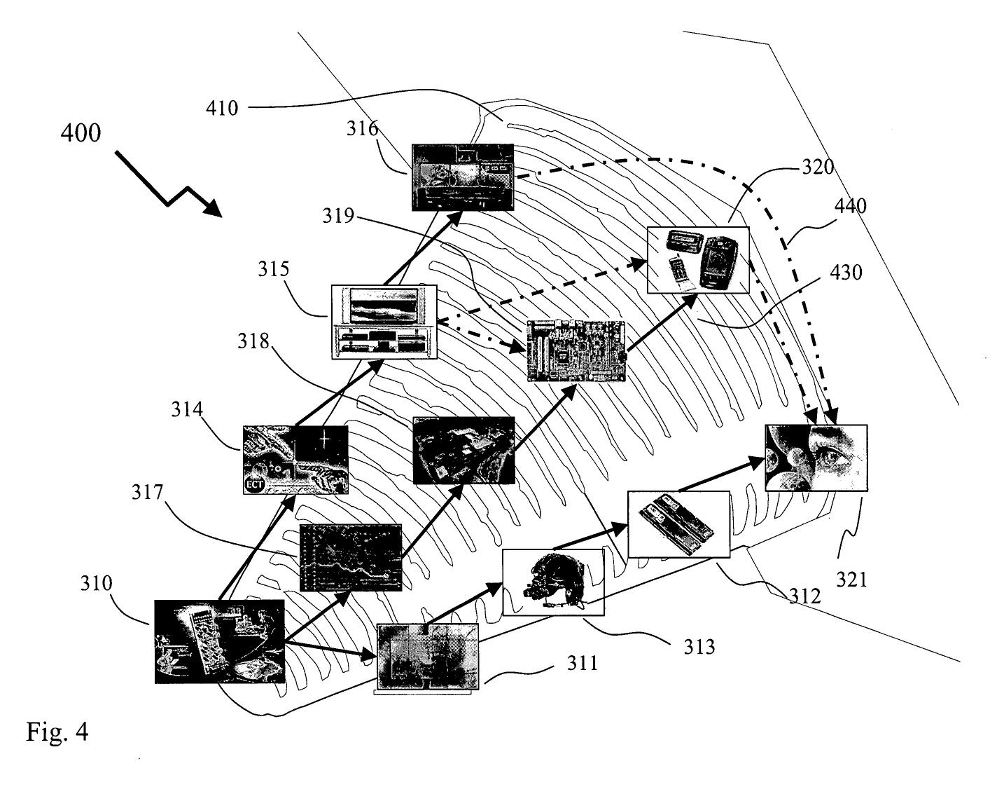

Whilst the approach described in FIGS. 3A and 3B mitigates some issues of the dynamic nature of presentations, it does not address all problems, and certainly does not help if the presentation flow 300A or 300B selected is actually incorrect and mismatched to the real client demands rather than the sales persons perceived demands. As such, a first embodiment of the invention is shown in FIG. 4 for the same slide-deck of 12 slides 310 through 321. Now a presenter selecting a slide-sorter option within the presentation application (not shown for clarity) is presented with a cone display image 400 onto which are mapped the slides 310 through 321. However, now the first slide 310 is shown at the apex of the cone display surface 410 and adjacent, but displaced along and around the cone display surface 410 are three slides 314, 317, and 311 respectively which represent potential jumps within the presentation flow, as selected by the presenter and entered into a slide transition menu element of the presentation software creating the overall slide-deck of 12 slides 310 through 321. As such, the presenter upon creating the 12 slides 310 through 321 can link slides such that they are associated with each other in a sequence, and at different points within the sequence a slide can potentially link to multiple other slides.

As such the presenter upon creating the slide-deck has associated slides 314, 317 and 311 as transition links from the first slide 310. Subsequently, the presenter has linked slides 313, 312 and final slide 321 in sequence from slide 311 to form a first sequence. Then a second sequence has been created from 317 using slides 318, 319, and 320 wherein the presentation links to the final slide 321. Finally the third sequence comprises slides 315 and 316, followed with a further transition from slide 316 to final slide 321. However, in entering the linkage of slide 315 to slide 316 the presenter has also considered it a likely jump in discussions to move from the product slide 315 to either circuit board slide 319 or wireless PDA slide 320. These are displayed upon the cone slide surface 410 as dot-dash links 440, rather than the primary solid links 430.

In accordance with the approach provided by this embodiment the cone display surface 410 may optionally be shown blank to the presenter with a linear series of icon images of the slide deck visible. In this manner the presenter may link slides within the slide deck, using for example cursor or typed instructions, and the displayed image of the cone display surface 410 would then be recalculated and redisplayed to show the presenter the current paths within the presentation that have been established, and the slides not currently included.

Optionally, the cone display surface 410 can be varied for the visualization of the linkages between elements of the presentation, such variants including, but not limited to spheres, cylinders, 3D organizational charts, and cubes, according to optionally the presenter or the application. Such visualizations may further be dynamically remapped from one visualization surface to another, for example under presenter direction or automatically, allowing improved ergonomics of the interface to the presenter.

Such a visual indication of the presentation structure allows for rapid adjustment of the presentation flow either for a subsequent presentation or during a presentation that is already in progress. For instance, the display icon images on the cone display surface 410 are double-clicked as with prior art displays to jump directly to the selected image, from which point the embedded link sequence are executed.

Further, during the execution of the presentation by the presenter the display optionally prompts the presenter to select which link they wish to pursue with the ongoing presentation. Hence, upon displaying for example slide 310 as linked within the exemplary embodiment of FIG. 4 a screen optionally is popped-up providing the three link paths from slide 310 to slides 314, 317 and 311 respectfully. As in many instances the presenter may not be fully familiar with the slide deck based on the slide numbers or slide titles, such a pop-up window optionally includes the icon images of each optional slide 314, 317, and 311. Such visualizations being beneficial to the presenter.

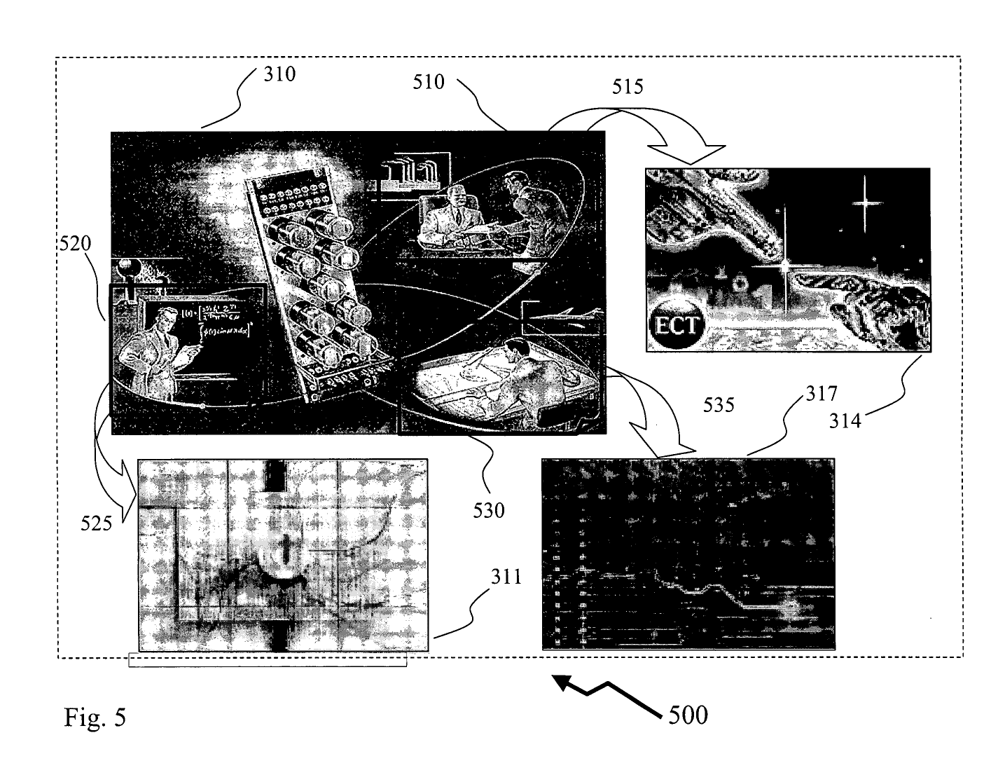

Referring to FIG. 5 there is shown another exemplary embodiment of navigating a presentation during its presentation to an audience, wherein a presenter is viewing the display on a screen different to that providing the images to the audience. As shown the presenter screen 500 shows the first slide 310 of the overall slide-deck, together with three links from the screen. Each link in the exemplary embodiment is shown through three elements, being fields 510, 520 and 530, jump arrows 515, 525 and 535, and link slides 314, 317, and 311.

As such the first field 510 highlights a portion of the display, shows a first link arrow 515 and first link slide 314. Selection of an element of this chain triggers the presentation software to jump to the first link slide 314. Similarly shown are second field 520, second link arrow 525, and second link slide 311. Finally, the third field 530, third link arrow, and third link slide 317 are shown. Whilst this image is presented to the presenter, the display screen for the audience is showing only the first slide 310. Based upon the presentation activities the presenter can therefore select the appropriate link to follow.

Many variants of this approach are employed without departing from the scope of the invention. Optionally, with a single display only the first slide 310 is displayed and three small windows 510, 520, and 530 are provided within the first slide 310. The motion of a cursor or another selection tool causes an icon image of the linked slide being displayed temporarily within the currently active window. Keyboard, mouse or other command entry would then cause the presentation to transition to the selected slide. As such, a cursor moving across window 510 causes an icon image of slide 314 to be displayed, the cursor within window 520 causing an image of slide 311 to be shown, and cursor placement within window 530 results in displaying the image of slide 317. A command selection at this point would transition the displayed image to slide 317. Such variants of the general principles described supra allow a presenter to operate with a single screen, such as using a single laptop or computer with a group.

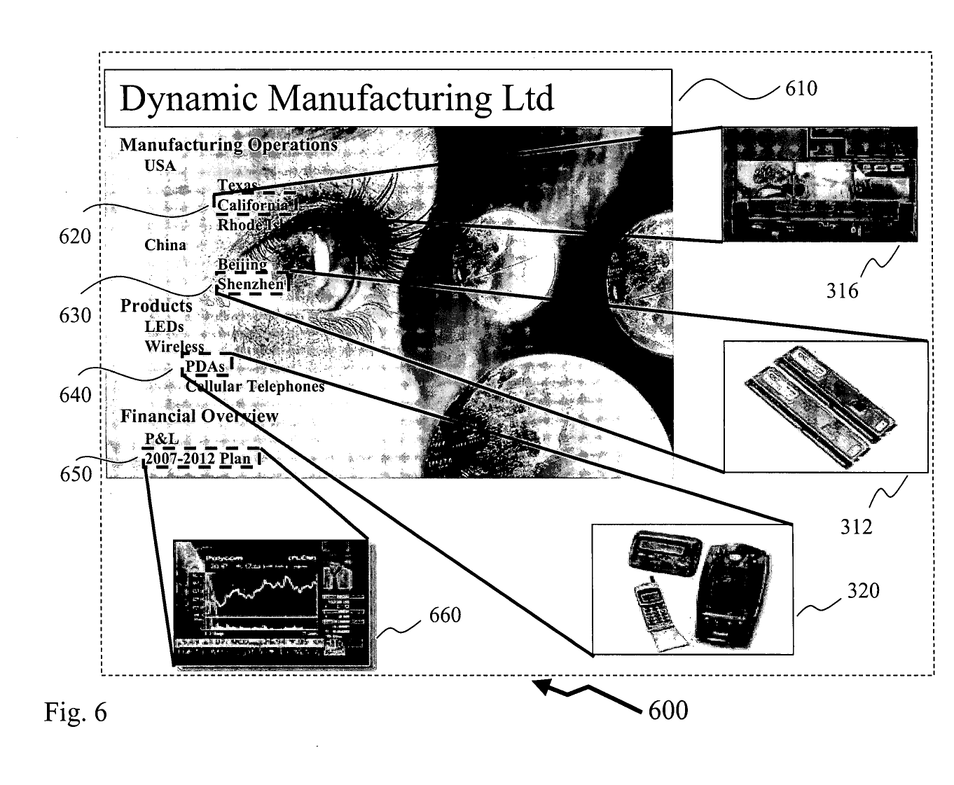

According to FIG. 6 a further embodiment of the invention is shown, as a presenter link image 600 of format similar to that described in relation to the presenter screen 500 of FIG. 5 but now embodying a common slide format of text, bullet points, and associated text based elements. As shown in FIG. 6 a slide image 610 is presented containing a title and text relating to the “Dynamic Manufacturing Ltd” business. As shown, this includes some text elements 620 through 650, which provide linkage to other presentation materials.

As shown, “California” 620 relating to a manufacturing location of “Dynamic Manufacturing Ltd” is linked to slide 316 portraying audio-visual equipment which represents the primary business of “California” 620. A second bulleted item of text “Shenzhen” 630 is linked to slide 312 portraying DRAM modules, which may be the primary business product line of the “Shenzhen” manufacturing operations of “Dynamic Manufacturing Ltd”. Next the third bulleted item “PDAs” 640 links to a product slide 320 as part of the wireless product portfolio of “Dynamic Manufacturing Ltd”.

The fourth identified bullet 650 representing “2007-2012 Plan” links to a financial slide 660. Prior to this point the slide links have all represented links to slides 310 through 321 of the same slide-deck 300 for ease of associating embodiments of the invention with the prior art. However, bullet “2007-2012 Plan” 650 represents a link to a different slide-deck, other than slide-deck 300. As such, for example, whilst a sales person would typically use only their slide-deck 300 they may occasionally require additional materials, such as in presenting to a company's procurement management group rather than the engineers specifying products. In this scenario providing financial data is appropriate and the exemplary embodiment allows the presenter to move smoothly from one presentation document to another without apparently changing any aspect of the presentation.

Such a linkage of presentations allows optionally a presenter to have a small, quickly accessed and displayed presentation outline from which they access one or more other presentations. Such an approach would for example, address the issue of providing a consistent organization chart as the presenter only has the link within their presentation and upon selection the appropriate document is accessed. Hence, a centralized copy of the organization chart may be updated and maintained and is the only source copy of the information. Such an embodiment provides enhanced security as rather than the information being permanently within a presentation slide-deck on a laptop, or other computing device, it is only loaded when the presenter is connected in a secure manner to the source slides.

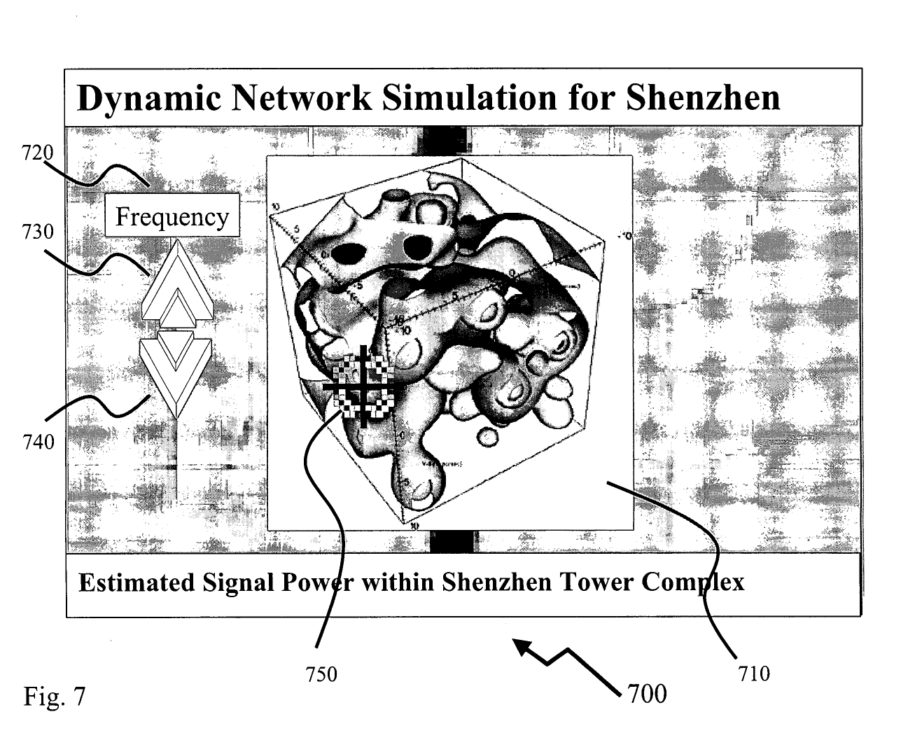

Now with reference to FIG. 7 a further embodiment of the document navigation methodology of the invention is described. Shown is a slide 700 comprising a title ‘Dynamic network simulation for Shenzhen” and having displayed a first 3D visualization 710 of the network simulation results. Such 3D visualization for example representing modeled signal intensity for an 850 MHz wireless signal from a base station within the “Shenzhen Tower Complex” of “Dynamic Manufacturing Ltd” for example. Also shown within the slide 700 are a pair of toggles 730 and 740 together with a title banner “Frequency” 720 to which the toggle pair 730 and 740 relate in function. Within this embodiment the selection of one or other toggle of the toggle pair 730 and 740 results in the frequency of the analysis being varied. Such variation being of a predetermined step or a next predetermined value within a range established by the presenter in creating the presentation.

In operation the selection of one or other of the toggle pair triggers the adjustment of the frequency and prompts redisplay of the resulting 3D visualization 710. Optionally, the toggle pair 730 and 740 is be replaced with a field into which a value or wireless standard is entered. If no other visualization is required, other than the one initially presented, there is no requirement to have generated, stored and linked multiple 3D visualizations 710.

This dynamic adjustment of the presentation information in relation to the audience participation and input into the presentation allows the presentation to incorporate decisions and variations arising from the discussion. For example, a presentation on financial planning for a business that reacts to a comment from one participant which results in adjustment of a projected revenue stream, cost of goods, supply chain issue, etc.

Maintaining such adjustments as the basis for further elements of the presentation is extremely beneficial, as this avoids the need for the meeting to adjourn, for the recalculation of all figures, for generation of a new presentation, and for the recommencement of the discussion.

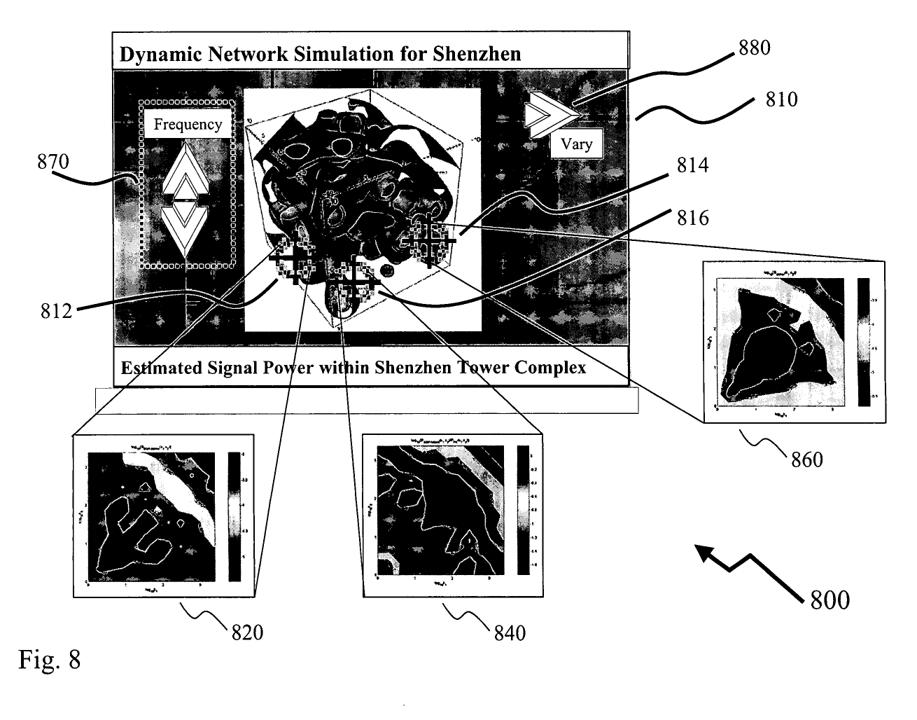

Also shown within the 3D visualization 710 of slide 700 is a locator cursor 750 that is under control of the presenter. Motion of the locator cursor 750 for example, providing a numerical display to adjust on the slide 700, not shown for clarity, in providing specific values to members of the audience in response to queries. Further, as shown in FIG. 8 the locator cursor 750 provides for dynamic navigation of refined analysis. As shown within slide 810 of FIG. 8 the toggle pair 870, being equivalent to 730 and 740 of FIG. 7 are similarly presented, as is a second toggle 880 which allows the parameter that is adjusted with the toggle pair 870 to be varied.

Now in relation to the movement of the locator cursor to a first position 812 and selection thereof, the displayed 3D visualization in the exemplary embodiment shifts to a localized 2D or 3D contour plot 820. If the presenter had instead moved the locator cursor to the second position 814, then upon selection of this location a different localized 2D or 3D contour plot 860 would have been displayed. Finally, a third position 816 of the locator cursor would have generated a third localized 2D or 3D contour plot 840.

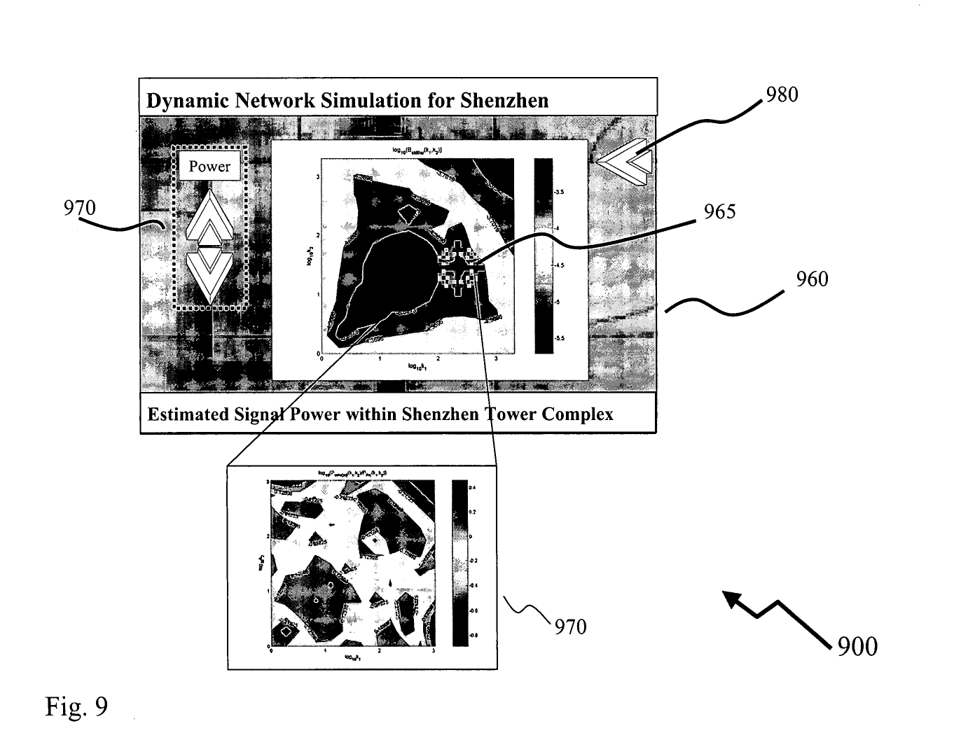

Next in relation to FIG. 9 the localized 2D or 3D contour plot resulting from the second position 814, is presented as slide 960, being the same 2D or 3D contour plot as localized 2D or 3D contour plot 860 of FIG. 8. Now, the second toggle 880 of FIG. 8 has also been engaged resulting in the toggle pair 970 relating to adjustment of the power of the wireless base station whose signal distribution within the “Shenzhen Tower Complex” is being modeled. The second toggle 880 now is displayed as a back-toggle 980. The locator cursor is now shown at a fourth position 965 which is a refined portion of that region of the 3D visualization 710 originally selected with the second position 814. Selecting this fourth position results in the localized 2D contour plot changing to that of the 2D plot 970.

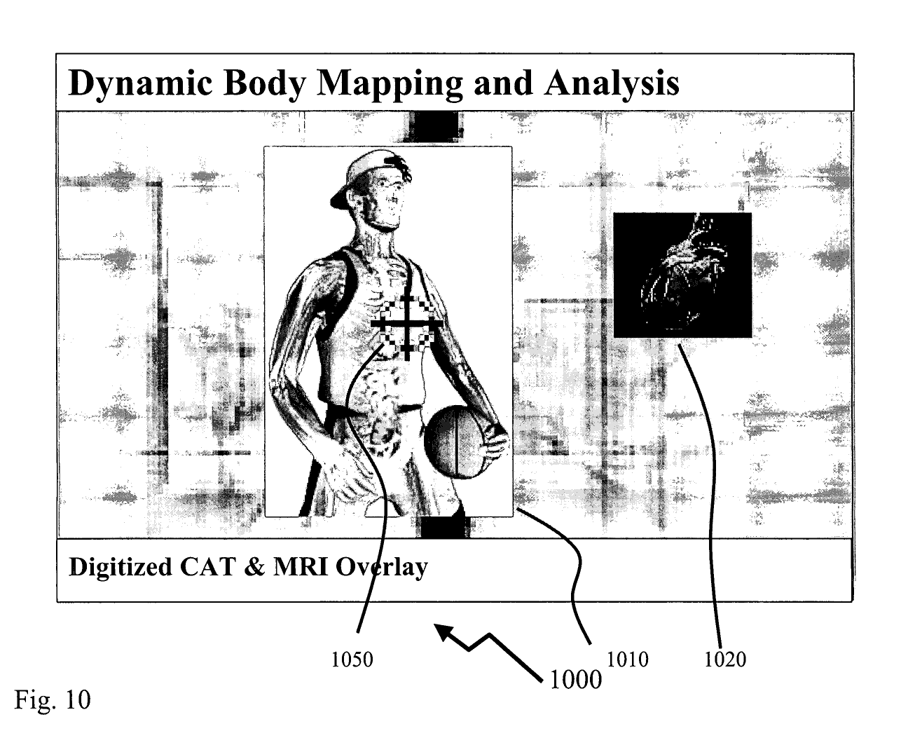

The navigation of elements of, or optionally complete, documents using three dimensional mapping is presented in a fifth embodiment of the invention described below in reference to FIG. 10. Shown is a slide 1000 comprising a title ‘Dynamic body mapping and analysis” and having displayed a first 3D visualization 1010 of a human body. Such 3D visualization for example representing a combination of medical imaging results. Also shown within the 3D visualization 1010 of slide 1000 is a locator cursor 1050 which is under control of the presenter. Motion of the locator cursor 1050 for example, over the human body triggering a variation in the image displayed within secondary 2D or 3D window 1020, for example relating to organs and as shown a heart. It would be apparent that the motion of the locator cursor 1050 over the 3D visualization 1010 allows the presenter to move to a following section of the document, for example simply by clicking on a portion of the human body within the 3D visualization 1010. The portions of the 3D visualization 1010 supporting links to other sections of the document could be highlighted as presented in respect of FIG. 10 by providing an image within the second window 1020, or optionally the color, shape of the locator cursor 1050 could be varied, audible or other visual indicators could be provided, and others known to those skilled in the art.

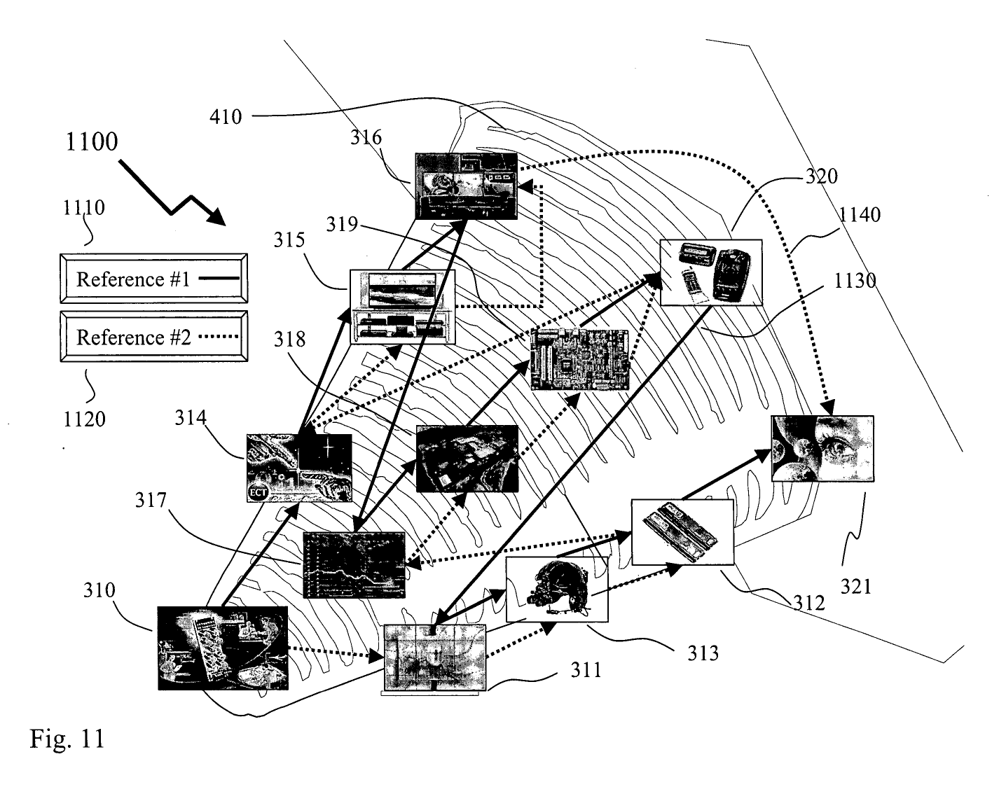

Next in relation to FIG. 11 a sixth embodiment of the invention in presented in respect of providing several frames of reference to a user navigating a document. As presented previously, in the first embodiment of the invention described in reference to FIG. 4 for the same slide-deck of 12 slides 310 through 321 is shown mapped as a cone display image 1100. As with FIG. 4 the first slide 310 is shown at the apex of the cone display surface 410 and adjacent, but displaced along and around the cone display surface 410 are three slides 314, 317, and 311 respectively, and around the cone display surface 410 are also displayed the remainder of slides 312-313, 315-316, 318-321. Now, however, the presenter is shown a first button icon “Reference #1” 1110 and second button icon “Reference #2” 1120 which represent two frames of reference for the slideshow created by the presenter.

Also shown within the cone display image 1100 are links between slides, such as solid reference link 1130 between slides 320 and 311, and dotted reference link 1140 between slides 316 and 321. As indicated within the first button icon “Reference #1” solid reference links 1130 display the slide sequence associated with a first frame of reference, such that the slide sequence is 310, 314, 315, 316, 317, 318, 319, 320, 311, 313, 312 and 321.

As indicated within the second button icon “Reference #2” 1120 dotted reference links 1140 display the slide sequence associated with a second frame of reference, such that the slide sequence would alternatively be 310, 311, 313, 312, 317, 318, 319, 320, 314, 315, 316, and 321. As such, the presenter can upon beginning the presentation select a frame of reference that aligns with the audience for this presentation. Optionally, upon reaching other points within the presentation the presenter may be provided with secondary frame of references, such that upon entering a product overview section of their presentation after completing a corporate overview they can select the frame of reference, and hence product sequence, matching their needs at that point.

It would be evident that the frames of reference can combine many of the embodiments presented supra, as well as allowing omission of elements of the document, linking to externally stored documents within some frames of reference and not others, and selecting different external document within different frames of reference.

Numerous other embodiments may be envisioned without departing from the spirit and scope of the invention.

What is claimed is:

1. A method comprising:
providing presentation data relating to a presentation, the presentation including a plurality of slides, the slides for being traversed in an order, the order relating to links between slides;
displaying a slide from the plurality of slides, the slide comprising at least a three dimensional representation of a portion thereof within a three dimensional space;
navigating within the three dimensional space of the three dimensional portion;
selecting within the three dimensional space a representation therein; and,
displaying another slide from the plurality of slides, the other slide selected in dependence upon the selected representation, different other slides displayed for different selected representations.

2. A method according to claim 1 wherein navigating within the three dimensional space comprises changing an angle of view of contents viewed within the three dimensional space.

3. A method according to claim 2 wherein navigating within the three dimensional space comprises changing a location from which to view and the angle of view of contents viewed within the three dimensional space.

4. A method according to claim 3 wherein some representations are visible within some views of the three dimensional space and other than visible within other representations are visible within some views of the three dimensional space.

5. A method according to claim 1 comprising:
providing a plurality of different orderings of the slides, the different orderings relating to different frames of reference;
selecting a frame of reference, and wherein the another slide from the plurality of slides is selected in dependence upon the selected representation and the frame of reference, different other slides displayed for different frames of reference.

6. A method according to claim 1 wherein the representations comprise representations of slides.

7. A method according to claim 1 wherein the representations comprise representations of three dimensional objects, the objects associated with the other slide.

8. A method according to claim 7 wherein the objects are associated with the other slide in an intuitive fashion.

9. A method according to claim 1 wherein the presentation data is at least indicative of the contents and layout of a three dimensional presentation.

10. A method according to claim 1 comprising:
upon selecting a representation, prompting a user with a request prior to executing a transition to the other slide.

11. A method according to claim 1 comprising:
upon selecting a representation; prompting at least one of a computer displaying the representation and a computer providing the portion of the presentation data associated with the representation with a request prior to executing a transition to the other slide.

12. A method according to claim 1 wherein data relating to the other slide is retrieved from a wide area network.

13. A method according to claim 12 wherein an address within the wide area network is determined in dependence upon at least a previous location of the user within the three dimensional presentation.

14. A method according to claim 1 wherein selecting a representation comprises navigating to the representation.

15. A method according to claim 1 wherein selecting a representation comprises navigating to a vicinity associated with the representation and selecting the representation.

16. A method according to claim 1 comprising;
prompting a user with a request prior to displaying the first slide of the plurality of slides;
obtaining a response to the request; and
determining that a predetermined subset of the representations are visible, the predetermined subset being determined in dependence upon the response.

17. A method according to claim 16 wherein,
obtaining a response comprises obtaining a security credential.

18. A method according to claim 17 wherein,
determining a subset comprises determining the validity of the security credential.

19. A computer-readable storage medium having stored thereon computer-executable instructions for a method of providing a user interface, the user interface comprising:
providing presentation data relating to a presentation, the presentation including a plurality of slides, the slides for being traversed in an order, the order relating to links between slides;
displaying a slide from the plurality of slides, the slide comprising at least a three dimensional representation of a portion thereof within a three dimensional space;
navigating within the three dimensional space of the three dimensional portion;
selecting within the three dimensional space a representation therein; and,
displaying another slide from the plurality of slides, the other slide selected in dependence upon the selected representation, different other slides displayed for different selected representations.

20. A computer-readable storage medium having stored thereon computer-executable instructions for a method of providing a user interface, the user interface comprising:
providing a computer-readable storage medium, the computer-readable storage medium having data stored thereon, the data comprising;
first data at least indicative of the contents and layout of a three dimensional presentation;
second data relating to a source of a plurality of sources, each source comprising a first predetermined region of the three dimensional presentation and associated with a predetermined transition from the source to a termination associated with the source; and
application data relating to software application for execution by a processor;
providing a first device, the first input device for receiving user input signals and for providing a first control signals to the processor, the first input device for providing data indicative of at least the location of the user within the three dimensional presentation;
providing a first display, the first display for providing to the user an image generated by the software application, the image comprising;
a three dimensional visualization associated with the first data, the first data being determined in dependence upon the first control signal; and
an object added to the three dimensional visualization, the object associated with the second data and being determined in dependence upon the first control signal; and
receiving a user input signal indicating a location matching one of the plurality of sources the first display providing to the user a second image generated by the software application, the second image associated with the termination of the source.

21. A computer-readable storage medium having stored thereon computer-executable instructions for providing a user interface, the user interface comprising:
a computer-readable storage medium having data stored thereon, the data comprising;
first data at least indicative of the contents and layout of a three dimensional presentation;
second data relating to a source of a plurality of sources, each source comprising a first predetermined region of the three dimensional presentation and associated with a predetermined transition from the source to a termination associated with the source; and
application data relating to software application for execution by a processor;
a first input device for receiving user input signals and for providing a first control signals to the processor, the first input device for providing data indicative of at least the location of the user within the three dimensional presentation;
a first display for providing to the user an image generated by the software application, the image comprising;
a three dimensional visualization associated with the first data, the first data being determined in dependence upon the first control signal; and
an object added to the three dimensional visualization, the object associated with the second data and being determined in dependence upon the first control signal; and
upon receiving a user input signal indicating a location matching one of the plurality of sources the first display providing to the user a second image generated by the software application, the second image associated with the termination of the source.
